(19) United States
(12) Patent Application Publication
(10) Pub. No.: US 2025/0289169 A1
(43) Pub. Date: Sep. 18, 2025

(54) AT LEAST PARTIALLY TRANSPARENT OPTICAL COMPONENT FOR USE IN A MOTOR VEHICLE

(71) Applicant: Hella GmbH & Co. KGaA, Lippstadt (DE)

(72) Inventor: Ludwig Knorr, Gütersloh (DE)

(21) Appl. No.: 19/077,134

(22) Filed: Mar. 12, 2025

(30) Foreign Application Priority Data
Mar. 18, 2024 (GB) 102024107579.1

(51) Int. Cl. B29C 44/10; B29K 105/04; B32B 5/20; B60Q 3/62; F21S 41/24; F21S 43/20; F21S 43/235; F21V 3/00; F21W 106/00

(52) U.S. Cl. CPC B29C 44/105; B32B 5/20; F21V 3/00; B29K 2105/041; B32B 2266/10; B32B 2307/414; B32B 2307/72; B32B 2307/7376; B32B 2551/00; B60Q 3/62; F21S 41/24; F21S 43/235; F21S 43/2605; F21W 2106/00

(57) ABSTRACT

An at least partially transparent optical component is provided for use in a motor vehicle. The component has a length (L) along a first axis (X), a width (B) along a second axis (Y) that is at a right angle to the first axis (X), and a thickness (D) along a third axis (Z) that is at a right angle to the first and second axes (X, Y). The length (L) and width (B) are significantly greater than the thickness (D). The thickness (D) of the component (10) is between 0.4 mm and 4.0 mm. The component is produced in an injection molded foam process.

### CROSS REFERENCE

This application claims priority to German Application No. 102024107579.1, filed Mar. 18, 2024, the entirety of which is hereby incorporated by reference.

### FIELD OF THE INVENTION

The present invention relates to an at least partially transparent optical component for use in a motor vehicle, and a method for the production thereof.

### BACKGROUND OF THE INVENTION

When producing optical components with large surface areas, such as outer lenses for lights, with an injection molding process, the molding material must flow through long flow paths. If the components are thin, this may be problematic. Moreover, it may not be possible to increase the thickness of the component due to the design and the functional requirements. Thickening the component also requires more material. For this reason, when producing thin optical components with large surface areas, numerous injection points are used for injecting the material forming the component. These multiple injection points can result in visible seams in the finished product, which may be located within the functional part of the component. This type of component may also be subject to warpage. FIG. 7 illustrates the prior art, in which an optical component 1 produced through injection molding has numerous seams 2. Potential injection points 3 for the molding material are also indicated by arrows in FIG. 7.

For certain uses of an optical component, e.g. for an optical fiber or ambient lighting, homogenous light distribution and a diffused appearance are the primary goals. This is obtained in the prior art through complex plastic structures or textures formed in the surface of the mold. These structures are difficult to create and therefore expensive. This also limits the freedom of design. FIG. 8 shows an optical component 1 according to this prior art, in which the upper surface of the component 1 has an optical structure 4. This structure 4 diffuses the light 5 passing through the component 1.

Another possibility is the use of light-diffusing materials. In this case, the plastic that is used for the component contains additives that diffuse light to obtain the desired appearance. FIG. 9 shows an optical component 1 from the prior art in which additives 6 inside the component 1 diffuse the light 5 passing through it.

### BRIEF SUMMARY OF THE INVENTION

The fundamental problem addressed by the present invention is to create an optical component of the above type that is less expensive to produce, and/or has fewer seams in the functional part, and/or allows for greater freedom of design. A method for the production thereof is also to be obtained by the invention.

The optical component has a length, width and thickness, the length and width being substantially greater than the thickness, which is between 0.4 mm and 4.0 mm, with the component being produced in an injection molded foam process.

The use of injection molded foam allows for a reduction in the viscosity of the molten material in the injection molding tool such that longer flow paths can be obtained with fewer injection points, and therefore with fewer seams in the finished product. The thinner product that can be obtained with injection molded foam reduces material consumption and lowers production costs. Because the finished product is thinner, and partially contains foam, it is also lighter.

The length and/or width of the component can be between 1 cm and 100 cm.

The component can have two opposing outer layers extending along the X and Y-axes that delimit the thickness thereof, which do not have a foam structure. These outer layers can bear directly on one another, or there can be a core layer between them that contains a foam structure with numerous foam cells.

The aim may be to reduce the thickness of the component to the point where the foaming is suppressed to the extent that a functional optical structure is obtained. If the two outer layers bear directly on one another, the component can be extremely thin, eliminating any foam structure, such that the light passing through it is not diffused.

The foam cells can be between 10 μm and 100 μm. Foam cells of 10 μm are relatively small, while those of 100 μm are relatively large.

The foam cells can be large enough that light passing through the component is at least partially diffused. These relatively coarse foam cells can assume the function of the optical structures from the prior art on the surface of the component and/or the diffusing additives inside the component. This use of foam cells allows for greater freedom of design.

The foam cells could also be of a size that does not diffuse light passing through the component. In this case, the foam cells do not significantly diffuse the passing through the component, allowing it to perform as intended.

The foam cells can have a density of 10⁴ cells/cm³ to 10⁸/cm³. This density affects the optical properties of the component.

The component can be a transparent lens or diffusing lens, or it can be an optical fiber. It can be used in a light for a motor vehicle, e.g. a headlamp or tail lights, or it can be used for lighting the interior of the motor vehicle.

The optical component may be produced using an injection molded foam process.

The injection molded foam process can make use of a physical foam and foaming agents such as nitrogen or carbon dioxide. The foaming can also be obtained chemically using a master batch that contains a gas. The properties of the foam structure, and therefore the optical effects, can be affected by the thickness of the final product and the foaming agent content, as well as by the injection molded foam process itself.

Expansion or compression can be carried out during or after the injection molded foam process in an expansion/compression process. This combination of processes can be used to affect the foam structure and therefore the properties of the component.

The temperature of the mold used in the injection molded foam process can be altered during the molding process, in particular in a cyclical manner. This can also be used to affect the flow properties of the material used in the molding process.

Counterpressure can also be obtained with a gas during the injection molded foam process. This can also affect the structure of the component.

The structure can also be affected by an insulating layer placed in the mold. This insulating layer can coat the surface of the mold, or it can be a film placed inside the mold.

The injection molded foam process can be combined with other injection molding processes using multiple components. By way of example, a lens produced in an injection molded foam process can then be at least partially coated with a black component.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a sectional view of a first embodiment of an optical component obtained with the invention.

FIG. 2 shows a sectional view of a second embodiment of an optical component obtained with the invention.

FIG. 3 shows a sectional view of a third embodiment of an optical component obtained with the invention.

FIG. 4 shows a sectional view of a fourth embodiment of an optical component obtained with the invention.

FIG. 5 shows a perspective view of a fifth embodiment of an optical component obtained with the invention.

FIG. 6 shows a perspective view of a sixth embodiment of an optical component obtained with the invention.

FIG. 7 shows a perspective view of an optical component from the prior art.

FIG. 8 shows a sectional view of an optical component from the prior art.

FIG. 9 shows a sectional view of an optical component from the prior art.

### DETAILED DESCRIPTION OF THE DRAWINGS

The same reference symbols are used in all the drawings for identical or functionally identical components. A Cartesian coordinate system is shown in some of the drawings for orientation purposes.

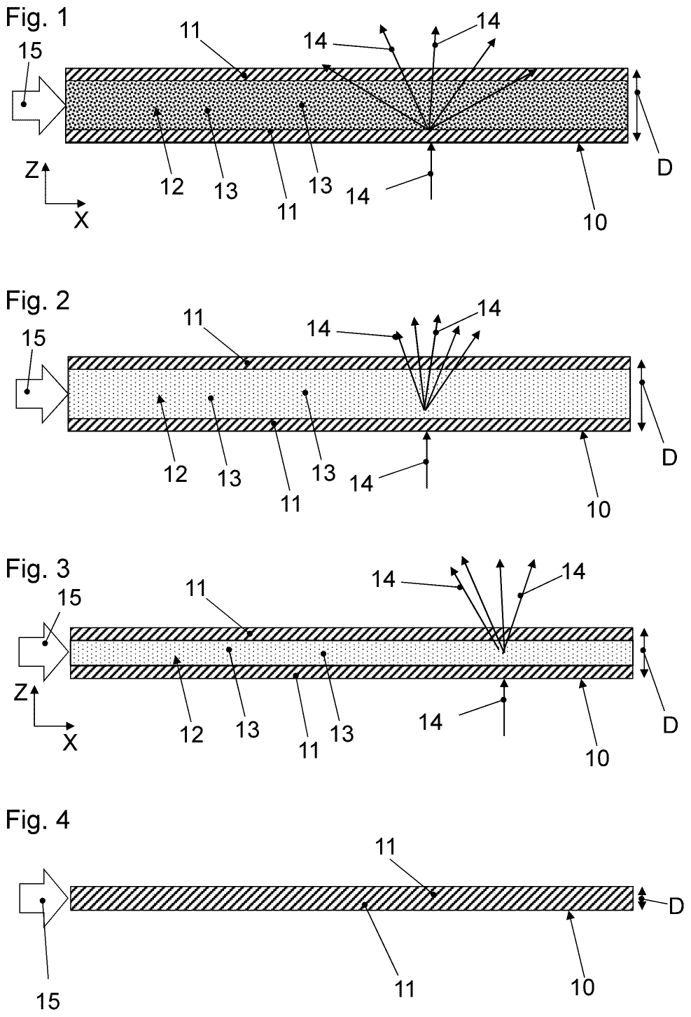

The embodiments of optical components 10 obtained with the invention that are shown in FIGS. 1 to 6 are produced in an injection molded foam process. The component 10 has a length L along the X-axis. The component 10 also has a width B along the Y-axis, at a right angle to the X-axis. The component 10 also has a thickness D along the Z-axis, which is at a right angle to both the X and Y-axes (see FIG. 6). The length L and width B are significantly greater than the thickness D. By way of example, the length L and/or width B of the optical component 10 can be between 1 cm and 100 cm, while the thickness D can be between 0.4 mm and 4.0 mm.

The components 10 shown in FIGS. 1 to 3 have two opposing outer layers 11 that extend in the plane formed by the X and Y-axes. These outer layers 11 delimit the component 10 along the Z-axis and have no foam structure. A core layer 12 is formed between the outer layers 11, which contains a foam structure with numerous foam cells 13.

The foam cells 13 can be between 10 μm and 100 μm. The foam cells of 10 μm are relatively small, while those of 100 μm are relatively large. The density of the foam cells can be between 10⁴ cells/cm³ and 10⁸ cells/cm³.

In the first embodiment, shown in FIG. 1, the component 10 is relatively thick and contains relatively large foam cells 13. The relatively large foam cells 13 result in a relatively strong diffusion of the light 14 passing through the component 10. In particular, the size of the foam cells 13 is such that the light 14 passing through the component is at least partially diffused. These foam cells 13 therefore assume the function of the optical structures on the outer surface of the component and/or the diffusing additives inside the component in the prior art.

In the second embodiment, shown in FIG. 2, the component 10 contains relatively small foam cells 13 and is basically the same thickness D as the first exemplary embodiment. The light 14 passing through the component 10 is diffused very little by the relatively small foam cells 13. In particular, these foam cells 13 are small enough that the light 14 passing through the component 10 remains effectively unaffected. These foam cells 13 have little or no effect on the light 14 passing through the component 10, such that the optical component 10 can perform the intended function, resulting in particular in a homogenous light distribution at the upper, light-exiting surface in FIG. 2.

In the third embodiment, shown in FIG. 3, the component 10 contains foam cells 13 that are the same size as those in the second embodiment. This third embodiment is thinner than the first and second embodiments. Because the outer layers 11 in the second and third embodiments are the same thickness, the core layer 12 containing the foam structure is thinner in the third embodiment. This shorter optical path through the core layer 12 further reduces the effect on the light 14 passing through the component 10 by the foam cells 13.

In the fourth embodiment, shown in FIG. 4, the component 10 is even thinner than in the third embodiment. This thickness D is such that the two outer layers 11 bear against one another along the Z-axis, such that there is no core layer 12 with a foam structure between them. Consequently, light 14 passing through the component 10 is not diffused by foam cells 13, such that the component 10 has the optical properties of a transparent panel.

The thickness D of the component 10 and the size of the foam cells 12 can be determined by the appropriate process parameters in the framework of the injection molded foam process. The reduction, or at least partial suppression of the foam structure can be achieved by the foaming agent and compression carried out during or after the injection molded foam process, in particular through compression or expansion thereof. A cyclical fluctuation of the temperature of the mold can also affect the thickness of the outer layers 11, the surface quality of the component 10, and the size of the foam cells 13. The structure of the component 10 can also be affected by counter pressure exerted by a gas during the injection molded foam process and/or by appropriate additives in the plastic used in the process.

The structure of the component 10 can also be affected by an insulating layer placed in the mold. This insulating layer can be a coating on the surface of the mold, or a film placed therein.

The injection molded foam process can be combined with other injection molding processes using multiple components. By way of example, the component 10 in the form of an outer lens produced in an injection molded foam process can be subsequently coated, at least partially, with a black component.

A injection point 14 for the material used in the injection mold is indicated by an arrow in each of the FIGS. 1 to 4. There is only one injection point in the embodiments shown in FIGS. 1 to 4, which is on the end of the component 10 at the left.

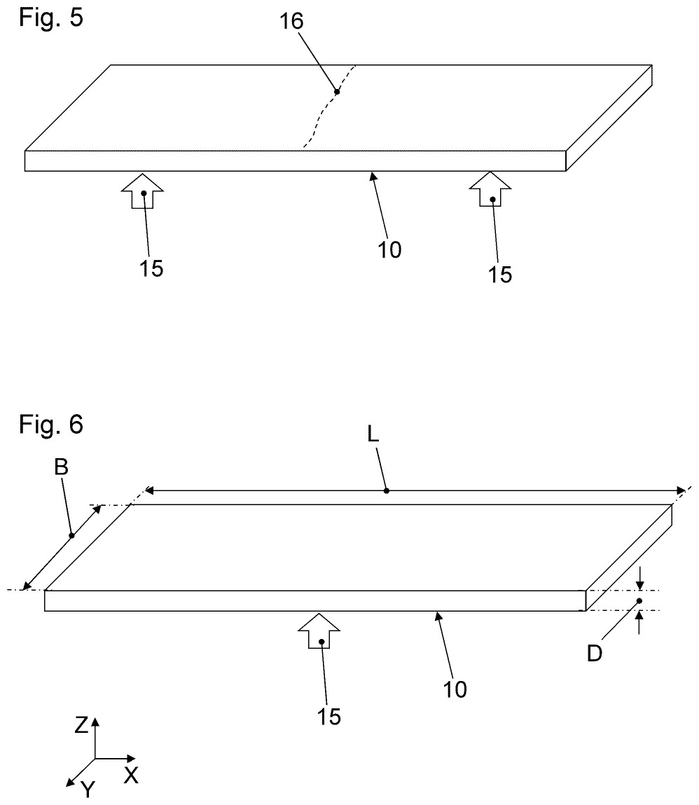

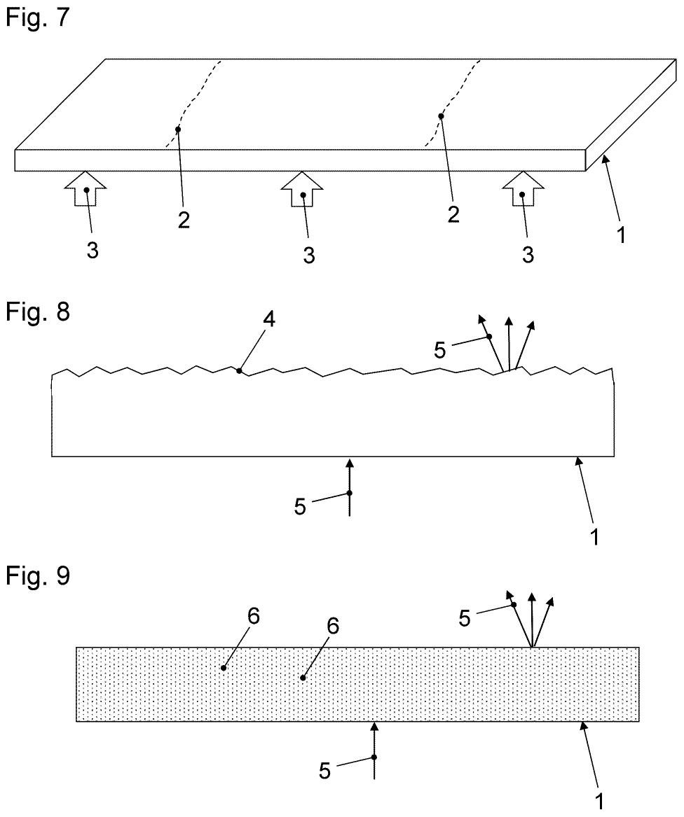

FIG. 5 shows a fifth embodiment of an optical component 10 in which the injection molded foam process is carried out with two injection points 15, such that the component 10 has a seam 16. These injection points 15 are on the bottom of the component 10.

FIG. 6 shows a sixth embodiment of an optical component 10 in which the injection molded foam process is carried out with only one injection point 15 on the bottom of the component 10, such that there is no seam 16.

### LIST OF REFERENCE SYMBOLS

1 optical component
2 seam
3 injection point
4 optical structure
5 light passing through the component
6 additives inside the component
10 optical component
11 outer layers of the component
12 core layer of the component
13 foam cells
14 light passing through the component
15 injection point
16 seam
X first axis
Y second axis
Z third axis
L length of the component
B width of the component
D thickness of the component

1. An at least partially transparent optical component for use in a motor vehicle, the component comprising:
a length (L) along a first axis (X);
a width (B) along a second axis (Y) that is at a right angle to the first axis (X); and
a thickness (D) along a third axis (Z) that is at a right angle to the first and second axes (X, Y),
wherein the length (L) and width (B) are significantly greater than the thickness (D),
wherein the thickness (D) of the component is between 0.4 mm and 4.0 mm, and
wherein the component is produced in an injection molded foam process.

2. The optical component according to claim 1, wherein the length (L) is between 1 cm and 100 cm, and/or the width (B) is between 1 cm and 100 cm.

3. The optical component according to claim 1, further comprising two opposite outer layers that extend in a plane formed by the first and second axes (X, Y), and delimit the component along the third axis (Z), wherein the outer layers do not contain a foam structure.

4. The optical component according to claim 3, wherein the two outer layers bear on one another along the third axis (Z), or wherein there is a core layer between the two outer layers along the third axis (Z), which contains a foam structure with numerous foam cells.

5. The optical component according to claim 4, wherein the foam cells are between 10 μm and 100 μm.

6. The optical component according to claim 4, wherein the foam cells are large enough to at least partially diffuse light passing through the component.

7. The optical component according to claim 4, wherein a density of the foam cells is between 10⁴ cells/cm³ and 10⁸ cells/cm³.

8. The optical component according to claim 1, wherein the component forms an optically transparent lens, an optically diffusing transparent lens, or an optical fiber.

9. The optical component according to claim 1, wherein the component is adapted for use in a light for a motor vehicle.

10. A method for production of an optical component according to claim 1, wherein the optical component is produced in an injection molded foam process.

11. The method according to claim 10, wherein the injection molded foam process is obtained through physical foaming with a foaming agent.

12. The method according to claim 10, characterized in that the injection molded foam process is obtained through chemical foaming with a master batch containing a gas.

13. The method according to claim 10 wherein compression and/or expansion takes place in a compression/expansion process, during or after the injection molded foam process.

14. The method according to claim 10, wherein a temperature of the injection molded foam mold fluctuates during the injection molded foam process, in particularly cyclically.

15. The method according to claim 10, wherein a gas counterpressure is used during the injection molded foam process.

16. The optical component according to claim 4, wherein the foam cells are small enough that light passing through the component is not diffused, and instead can pass through the component comparatively intact.

17. The method according to claim 11, wherein the injection molded foam process is obtained through physical foaming with a foaming gas.

18. The method according to claim 17, wherein the foaming gas is nitrogen or carbon dioxide.

19. The method according to claim 14, wherein the temperature of the injection molded foam mold fluctuates cyclically during the injection molded foam process.
